(19) United States
(12) Patent Application Publication
(10) Pub. No.: US 2012/0034351 A1
(43) Pub. Date: Feb. 9, 2012

(54) CARBONATED JELLY BEVERAGE WITH INCLUSIONS

(75) Inventors: Vidya Sridhar, Pune (IN); David Bell, Yorktown Heights, NY (US); Casey McCormick, Poughquag, NY (US); Manisha Lokre, Fort Lee, NJ (US); Mohamed Zaki Badaoui Najjar, Valhalla, NY (US)

(73) Assignee: PEPSICO, INC., Purchase, NY (US)

(21) Appl. No.: 13/179,708

(22) Filed: Jul. 11, 2011

Related U.S. Application Data
(60) Provisional application No. 61/363,850, filed on Jul. 13, 2010.

(51) Int. Cl. A23L 1/052; A23L 1/0524; A23L 2/58; A23L 1/0534; A23L 2/54; A23L 2/68; A23L 1/0526; A23L 1/054; A23L 1/0532; A23L 2/56

(52) U.S. Cl. 426/262; 426/573; 426/575; 426/577

(57) ABSTRACT

A carbonated gelatinous beverage containing inclusions and methods for making same.

### FIELD OF THE INVENTION

This application claims priority to U.S. Provisional Patent Application No. 61/363,850 filed on Jul. 13, 2010, the disclosure of which is expressly incorporated herein by reference in its entirety.

The present invention relates generally to a carbonated gelatinous beverage and method for making same. More particularly, the present invention relates to a carbonated beverage comprising a soft and easy-to-consume gel having inclusions suspended therein, and a method for making this beverage.

### BACKGROUND OF THE INVENTION

The beverage of the present invention has a soft jelly texture than enhances the fun experience of drinking a beverage. The beverage further contains inclusions such as beads or fruit bits. The soft jelly texture beverage with such inclusions is drinkable using a straw.

### BRIEF SUMMARY OF THE INVENTION

The present invention relates to a shelf stable, carbonated, flavored jelly beverage with inclusions suspended uniformly within the beverage. These inclusions include, without limitation, gel beads, fruit pieces, seeds, or processed plant products ranging in size between 0.1 mm to 10.0 mm. The inclusions in the beverage vary anywhere from about 0.1 to about 1.5% on wt/wt basis. The present invention is further directed to methods for making this beverage.

### BRIEF DESCRIPTION OF THE DRAWINGS

FIG. 1 is an exemplary process flow diagram of a process for making the beverage of the present invention

FIG. 2 is a second exemplary process flow diagram of a process for making the beverage of the present invention.

### DETAILED DESCRIPTION OF THE INVENTION

The present invention relates to a carbonated gelatinous beverage. More specifically, the present invention relates to soft jelly textured drinkable beverage containing gum and additional ingredients including, but not limited to, food-grade acid(s), ion sequestering agent(s), calcium source(s), bulking agent(s), nutritive and non-nutritive sweetener(s), preservative(s), color(s), flavor(s), functional ingredient(s), or combinations of these ingredients.

Gums that may be used in the gum-based gel include, but are not limited to: carrageenan, locust bean gum, xanthan gum, gellan, pectin, carboxy methyl cellulose, and combinations thereof.

The gum-based gel may also include at least one ion sequestering agent such as sodium citrate or potassium citrate and at least one source of calcium such as calcium disodium edetate, calcium citrate, calcium lactate, calcium chloride, and calcium carbonate. The gum-based gel may also include at least one bulking agent such as sucrose, maltodextrin, dextrin, and pectin, and at least one food-grade acid such as citric acid, ascorbic acid, acidic acid, acetic acid, lactic acid, formic acid, oxalic acid, tartaric acid, fumaric acid, malic acid, and phosphoric acid.

Additionally, or alternatively, the gum-based gel may also include at least one sweetener (nutritive and/or non-nutritive), at least one color, at least one flavor, at least one functional ingredient or combinations thereof. Examples of such nutritive, and non-nutritive sweeteners include without limitation, to sucrose, high fructose corn syrup, fructose, dextrose, sucralose, aspartame, acesulfame K, saccharin, cyclamate, alitame, natural sweeteners such as honey, agave, and all brands of stevia (Reb A extract). One of ordinary skill in the art at the time of the invention would appreciate that other sweeteners may be used in accordance with the present invention. Functional ingredients may include vitamins and antioxidants.

At least one preservative may be added to the beverage base. These preservatives include, but are not limited to, calcium disodium edetate, sodium hexa meta phosphate, benzoic acid, sorbic acid, potassium sorbate, sodium benzoate, potassium cinnamate, lauric arginate (mirenat) and combinations thereof. The pH of the jelly beverage with inclusions is from about 3 to about 4, generally between 3.2 and 3.6, such as 3.4.

Additional ingredients such as food-grade colors derived from both natural and artificial sources of color consisting (Yellow 5, Yellow 6, Red 40, Blue 1, cochineal extract, beta carotene, fruit based colors such as mango orange, vegetable based colors, lycopene, natural blue and combinations thereof), and flavors and flavor modifiers (lime, lemon, orange, grapefruit; strawberry, blueberry, josta berry, fruit, cherry, malt, beer, chocolate, coffee, tea, acai, pomegranate, hibiscus, tamarind, mango, peach, pineapple, melon, watermelon, insoluble colors, taste modifier and combinations thereof) may also be added to the beverage base in accordance with the present invention.

Inclusions may include, without limitation, microspheres, gel beads, fruit pieces, seeds, or processed plant products. The gel beads could be made with agar, alginate, pectin, wax, carboxymethylcellulose, guar, cellulose or combinations of one or more of such ingredients. The beads can be of generally consistent size or vary in size, and range in size between 0.1 mm to 10 mm, for example about 0.1 mm to about 5 mm. These inclusions may be colored, flavored, contain filler ingredients such as silica, preservatives, acid, functional ingredients such as vitamins or antioxidants, fiber and combinations of these ingredients.

Fruit inclusions include, without limitation, real fruit pieces, fruit peels (grapefruit, lemon, orange) fruit pulp (orange, lemon, grapefruit), fruit zest (lemon, orange) or processed fruit meat from berries, tropical fruits, citrus and combinations of these fruits. Other inclusions include without limitation coconut meat, black pepper, basil seed, fennel seed, ginger, wild starch pearls, tapioca pearl, mint leaves, kalamansi peels, fennel root, and combinations of these ingredients. The inclusions may be of generally consistent size or vary in size and range in size from about 0.1 mm to 5 mm in dimensions. The fruit bits could be colored, flavored, and/or contain functional ingredients as listed above.

In one aspect of the present invention, The carbonated gelatinous beverage with inclusions is prepared by introducing the gum in combination with a source of calcium ion, a bulking agent, such as sucrose, an ion sequesterant, and at least one preservative into a mixer. The gum is hydrated in hot water for about 5-20 minutes at a temperature of about 180-220° F., such as 5 minutes at 200-210° F., to create a hydrated gum mixture. The remaining ingredients (such as food-grade acid, color) are added to the hot gum mixture (200-210° F.). Citric acid is then added and the mixture is cooled to 110-125° F. Flavor and inclusions are added while the mixture is cooling (<100° F.). The amount of gum in the final product ranges from about 0.005% to 0.05% w/v, for example, about 0.01% to about 0.035% w/v of gum may be present in the final product. Finally, the beverage is carbonated and filled into packaging. Alternatively, the inclusions may be added to the beverage after carbonating the beverage.

In another aspect of the present invention, the gum is hydrated first by high shearing the mixture at a speed of about 1000-2000 rpm for 5-20 minutes in hot water (125-145° F.), such as 5 minutes at 140° F. The high sheared gum is additionally hydrated in hot water for about 5-20 minutes at a temperature of about 150-220° F., such as 5 minutes at 200-210° F. The remainder of the ingredients (such as acid, color) are added to hot gum mixture (200-210° F.). Citric acid is then added and mixture is cooled to 110-125° F. Flavor and inclusions are added while mixture is cooling (<100° F.). Finally, the beverage is carbonated and filled into packaging (batched to beverage with a beverage throw of (1+0)).

In yet another aspect of the present invention, the beverage could be batched as a syrup and carbonated water could be used to throw the syrup into beverage strength. This throw could vary anywhere between (1+4) through (1+1). Upon cooling the jelly texture develops over time that helps with suspension of beads and providing the fun experience of drinking a beverage with inclusions.

Examples of several aspects of the present invention are as follows:

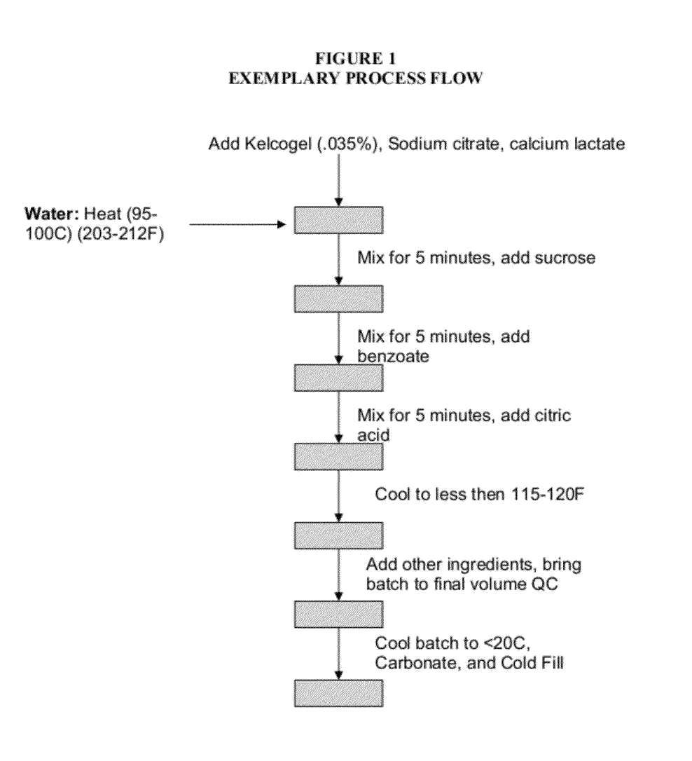

As shown in FIG. 1, water is heated to 200-210° F. and gellan gum is added slowly to the hot water. Next, sodium citrate and calcium lactate are added to the mixture and mixed for about 5 minutes. Sucrose is then added to the mixture and mixed for about 5 minutes followed by addition of sodium benzoate which is once again mixed for 5 minutes. Lastly, citric acid is added to the mixture. Cold water is then added to the mixture to cool the mixture to 115-120° F. until the mixture is cooled to about 65° F. Flavors and inclusions are added to the mixture, during cooling or after the mixture has cooled to less than about 100° F. The cooled mixture is then carbonated and filled into containers. Alternatively, the inclusions may be added after carbonating the beverage.

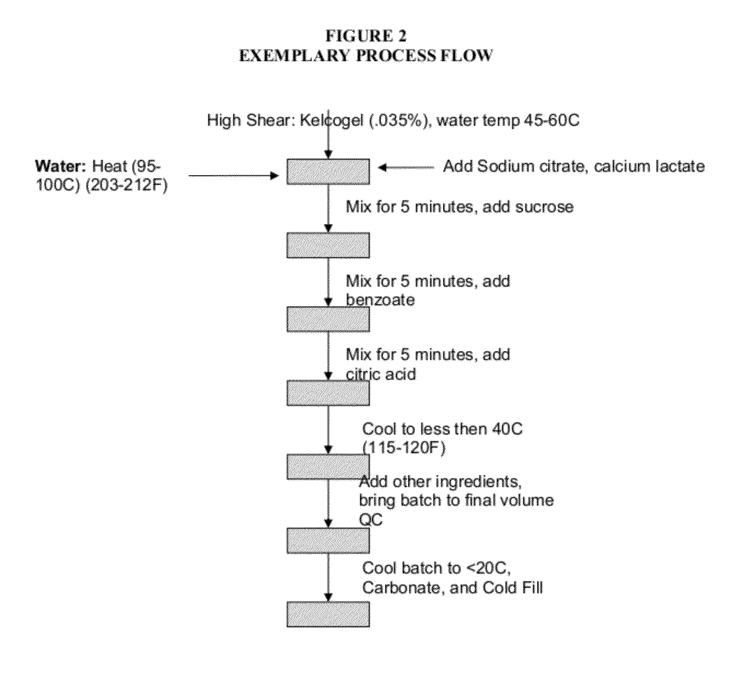

As shown in FIG. 2, the carbonated gelatinous beverage may also be prepared using high shear processing. For example, water is heated to about 135-145° F. The gellan gum is added to the heated water while high shearing the mixture. This mixture is subjected to high shear (about 1,600 rpm) for about 5 minutes. Next, this gum mixture is added to water heated to 200° F. Sodium citrate and calcium lactate are then added to the mixture and mixed for 5 minutes, followed by the addition of sucrose (mixed for 5 minutes) and then sodium benzoate (mixed for 5 minutes). Lastly, citric acid is added to the mixture. Cool water is then added to the mixture to cool the mixture to 115-120° F. and the mixture is further cooled to about 65° F. Flavors and inclusions are added to the mixture during cooling or after the mixture has cooled to less than about 100° F. This mixture is then carbonated and filled into containers. Alternatively, the inclusions may be added after carbonating the beverage.

Exemplary product formulas of the present invention are as follows:

### EXAMPLE 1

| | UNIT WT. | BATCH WT. | BATCH WT. |
|---|---|---|---|
| INGREGIENT | LBS | LBS | G |
| Sucrose | 910.00 | 60.67 lbs | 27517.9 grams |
| Gellan gum | 2.71 | 0.18 lbs | 81.9 grams |
| Na Citrate | 4.51 | 0.30 lbs | 136.3 grams |
| Calcium Lactate | 3.75 | 0.25 lbs | 113.5 grams |
| Na Benzoate | 3.00 | 0.20 lbs | 90.8 grams |
| Citric Acid | 18.78 | 1.25 lbs | 567.8 grams |
| Flavor | 17.44 | 1.16 lbs | 527.4 grams |
| Finish Bev. Yield | 900.00 gal | | 60.00 gal |

| TEST | TARGET | RANGE |
|---|---|---|
| CO2 | 2.7 | 2.8-3.2 |
| Brix | 12.00 | 11.8-12.2 |
| T.A. | 39.04 | 37.86-40.21 |
| pH | 3.3 | 3.10-3.30 |

### EXAMPLE 2

| | UNIT WT. | BATCH WT. | BATCH WT. |
|---|---|---|---|
| INGREGIENT | LBS | LBS | Grams |
| Sucrose | 910 | 151.67 | 68796.36 |
| Gellan gum | 2.63 | 0.44 | 199.58 |
| Na Citrate | 4.51 | 0.75 | 340.19 |
| Calcium Lactate | 5.63 | 0.94 | 426.38 |
| Na Benzoate | 3.00 | 0.50 | 226.80 |
| Citric Acid | 18.78 | 3.13 | 1419.74 |
| Flavor | 17.47 | 2.91 | 1319.95 |
| Finish Bev. Yield | 900.00 gal | | 150.00 gal |

| TEST | TARGET | RANGE |
|---|---|---|
| CO2 | 2.7 | 2.5-3.0 |
| Brix | 12 | 11.8-12.2 |
| T.A. | 39.04 | 37.86-40.21 |
| pH | 3.5 | 3.3-3.7 |

Example 3 (reduced sugar compared to Examples 1 and 2):

| | UNIT WT. | BATCH WT. | BATCH WT. |
|---|---|---|---|
| INGREGIENT | LBS | LBS | Grams |
| Sucrose | 672.83 | 112.14 | 50865.85 |
| Gellan gum | 1.13 | 0.19 | 86.18 |
| Na Citrate | 4.51 | 0.75 | 340.19 |
| Calcium Lactate | 2.26 | 0.38 | 172.37 |
| Na Benzoate | 3.00 | 0.50 | 226.80 |
| Citric Acid | 18.78 | 3.13 | 1419.74 |
| Flavor | 26.21 | 4.37 | 1982.20 |
| Sucralose/ASK | 1.5 | 0.26 | 117.93 |
| Finish Bev. Yield | 900.00 gal | | 150.00 gal |

| TEST | TARGET | RANGE |
|---|---|---|
| CO2 | 2.7 | 2.5-3.0 |
| Brix | 9.4 | 9.2-9.6 |
| T.A. | 39.04 | 37.86-40.21 |
| pH | 3.5 | 3.3-3.70 |

While the invention has been particularly shown and described with reference to various embodiments, it will be recognized by those skilled in the art that modifications and changes may be made to the present invention without departing from the spirit and scope thereof. The scope of the invention should therefore be determined not with reference to the above description but with reference to the appended claims along with their full scope of equivalents.

What is claimed is:

1. A carbonated gelatinous beverage comprising: carbonated water and gum, wherein the water and gum form a soft jelly texture.

2. The carbonated gelatinous beverage of claim 1 wherein the gum is selected from carrageenan, locust bean gum, xanthan gum, gellan, pectin, carboxy methyl cellulose, and combinations thereof.

3. The carbonated gelatinous beverage of claim 1 wherein the gum is gellan gum.

4. The carbonated gelatinous beverage of claim 1 further comprising at least one of food-grade acid(s), ion sequestering agent(s), calcium source(s), bulking agent(s), nutritive and non-nutritive sweetener(s), preservative(s), color(s), flavor(s), functional ingredient(s), or combinations of these ingredients.

5. The carbonated gelatinous beverage of claim 1 further comprising inclusions suspended in the gelatinous beverage.

6. The carbonated gelatinous beverage of claim 5 wherein the inclusions are microspheres or gel beads.

7. The carbonated gelatinous beverage of claim 5 wherein the inclusions are fruit pieces.

8. The carbonated gelatinous beverage of claim 1 wherein the beverage is drinkable from a straw.

9. The carbonated gelatinous beverage of claim 1 wherein the amount of gum in the final beverage is about 0.005% to 0.05% w/v of the final beverage

10. A method of forming a carbonated gelatinous beverage with inclusions comprising
a) mixing a gum, a source of calcium ion, a bulking agent, an ion sequesterant, and at least one preservative to form a mixture,
b) hydrating the mixture in hot water for about 5-20 minutes at a temperature of about 180-220° F., to create a hydrated gum mixture,
c) adding at least one of an acid or color and heating the resulting mixture to 200-210° F.,
d) adding citric acid and cooling the mixture to 110-125° F.,
e) adding flavor and inclusions during cooling to <100° F. to form a beverage, and
f) carbonating the beverage.

11. A method of forming a carbonated gelatinous beverage with inclusions comprising
a) adding gum to water heated to 125-145° F. and mixing at high shear at a speed of about 1000-2000 rpm for 5-20 minutes to hydrate the gum,
b) adding additional hot water and allowing the high sheared gum to further hydrate for about 5-20 minutes at a temperature of about 180-220° F.,
c) adding at least on of an acid or color and heating the resulting gum mixture to 200-210° F.,
d) adding citric acid and cooling the mixture to 110-125° F.,
e) adding flavor and inclusions during cooling <100° F. to form a beverage, and
f) carbonating the beverage

12. A method of forming a carbonated gelatinous beverage with inclusions comprising:
a) adding gum to water heated to 125-145° F. and mixing at high shear at a speed of about 1000-2000 rpm for 5-20 minutes to hydrate the gum,
b) adding additional hot water and allowing the high sheared gum to further hydrate for about 5-20 minutes at a temperature of about 180-220° F.,
c) adding at least on of an acid or color and heating the resulting gum mixture to 200-210° F.,
d) adding citric acid and cooling the mixture to 110-125° F.,
e) adding flavor during cooling <100° F. to form a beverage,
f) carbonating the beverage, and
g) adding inclusions to the carbonated beverage.
